(19) United States
(12) Patent Application Publication
(10) Pub. No.: US 2006/0232724 A1
(43) Pub. Date: Oct. 19, 2006

(54) STRUCTURE OF THE DUAL-DISPLAY LIQUID CRYSTAL DISPLAY

(76) Inventor: Min-Sheng Hsieh, Taipei City (TW)

Correspondence Address: NORTH AMERICA INTELLECTUAL PROPERTY CORPORATION, P.O. BOX 506, MERRIFIELD, VA, 22116, US

(21) Appl. No.: 11/161,526

(22) Filed: Aug. 8, 2005

(30) Foreign Application Priority Data
Apr. 15, 2005 (TW) 094112033

(51) Int. Cl. G02F 1/1335

(52) U.S. Cl. 349/64

(57) ABSTRACT

The present invention relates to a structure of the liquid crystal display comprises a back light unit, a main display panel formed in the side of the back light unit and a sub display panel formed in the other side of the back light unit and a diffused film formed between the main display panel and the sub display panel. The diffused film is able to be passed by one polarized light which has the specific direction and reflex the other polarized light which is vertical with the specific direction.

### BACKGROUND OF THE INVENTION

1. Field of the Invention

The present invention relates to a structure of a dual-display LCD, and more particularly, to a structure of a dual-display LCD to prevent a shadow of a main display panel.

2. Description of the Prior Art

The LCD is a thin and save electricity flat display, it uses the different liquid crystal revolving angles and the polarized light layer beside the liquid crystal to control the transmittance. The brightness is controlled by the transmittance. When the color is constant, the liquid crystal is steadfast, that is why the LCD has stable appearance and no twinkle. Because of the above-mentioned advantages, the LCD applies in popularly scope i.e., the mobile phone, PDA, notebook and the digital camera. Owing to new products enter the market fast, the technology of the LCD improves. The least fashion is dual-display LCD applies in various products.

For example, many displays shell type mobile phones are dual-display with liquid crystal displays. The dual-display LCD has a main display panel and a sub display panel. The sub display panel emits light from a rear cover of the mobile phone, shows a simple words or an images, and the uses will realize the base information form the sub display panel before they answer the phone. Besides, the main display panel positions in the mobile phone to show a main and complex words and image.

Please refer to FIG. 1, FIG. 1 is a liquid crystal display 100 has a single light guide plate 102 according to the prior art. The liquid crystal display 100 has one light guide plate 102 applies for a dual display mobile phone. A light path is beginning from the light guide plate 102 and divides into two paths, one is toward a main display panel 114, the other one is toward a sub display panel 134.

When a light is shot from a light source into a light guide plate 102, the light guide plate 102 will guide the light to divide into the above-mention two paths into the main display panel 114 and the sub display panel 134. In FIG. 1, only drawing paths I and II illustrate. As FIG. 1 shown, the paths I and II are shot toward the main display panel 114 and the sub display panel 134 individually. In path II, the light is shot into light guide plate 102 and sequentially gets into a diffuser 112, a horizontal prism sheet 114, a vertical prism sheet 116, and the light without a frame 116 and a shade tape 131 covers is able to reach the sub display plane 134. The sub display plane 134 comprises a first polarized light layer 133, a second polarized light layer (not shown), two base plates (not shown) and liquid crystal (not shown). Besides, the first polarized light layer 133 divides the light into a P polarized light and a S polarized light, absorbs one of the P polarized light and the S polarized light. In FIG. 1, the S polarized light is absorbed and only the P polarized light gets into the sub display panel 134.

According to path I, the light is shot into light guide plate 102 and sequentially gets into the diffuser 122, the horizontal prism sheet 124, the vertical prism sheet 126, and the light is reflected by the frame 128, the light shoots into the diffuser 104, the horizontal prism sheet 106, the vertical prism sheet 108, the diffuser 110, and the light without the shade tape 112 covers is able to reach the main display plane 114, finally, the light is filter by the polarized light layer 113 and shoot from the main display panel 114.

Because the liquid crystal display 100 has single light guide plate, the main display panel 114 and the display panel 134 use the same light guide plate 102 and light source, the light into the light guide plate 102 needs to divide to the main display panel 114 and the sub display panel 134, that is why the main display panel 114 has less light source and get shadow, and how to decrease the shadow of the main display panel 114 happen is important issue in the dual display LCD manufacturer.

### SUMMARY OF THE INVENTION

The present invention relates to a structure of a dual-display LCD has a film to solve the above-mention shadow of the main display panel.

The embodiment of the present invention relates to a structure of the liquid crystal display. It comprises a back light unit, a main display panel formed in the side of the back light unit and a sub display panel formed in the other side of the back light unit and a diffused film formed between the main display panel and the sub display panel. The diffused film is able to be passed by one polarized light which has the specific direction and reflex the other polarized light which is vertical with the specific direction.

The LCD of the present invention has the film and the main display panel has more polarized light reflects from the film. The present invention decreases the shadow happening of the main display panel and the main and sub display panel both have enough light.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a liquid crystal display has a single light guide plate according to the prior art.

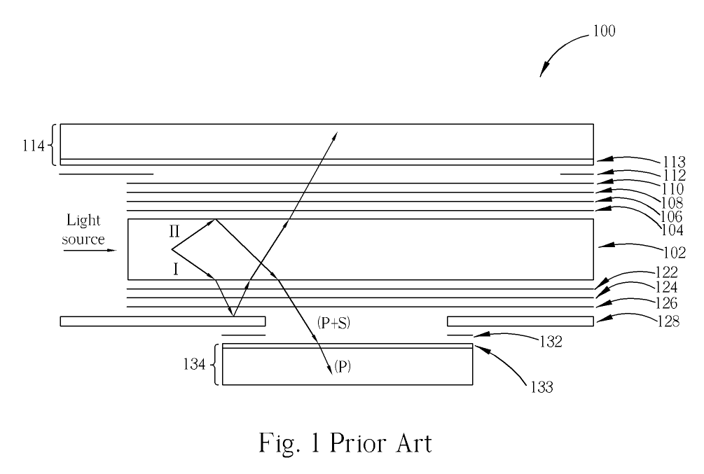

FIG. 2 is a liquid crystal display has a single light guide plate according to the present invention.

### DETAILED DESCRIPTION

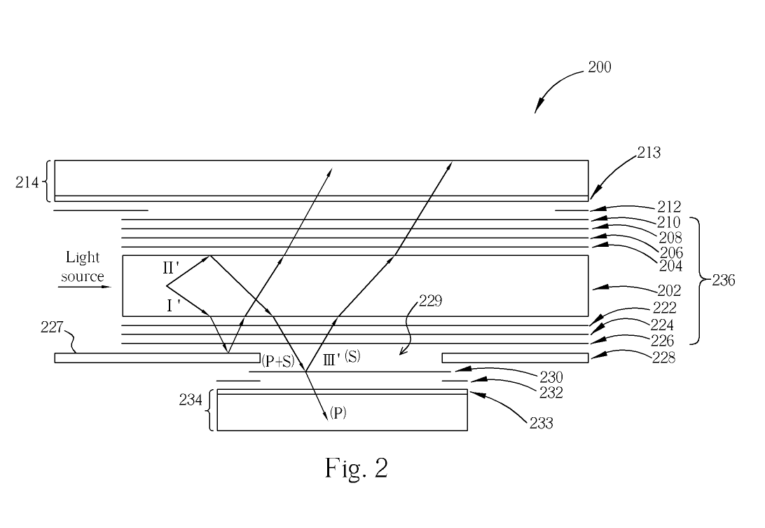

Please refer to FIG. 2, FIG. 2 is a liquid crystal display 200 has a single light guide plate 202 according to the present invention. The liquid crystal display 200 has one light guide plate 202 applies for a dual display mobile phone. The liquid crystal display 200 comprises a main display panel 214 on the side of a backlight module 236, a shade tape 212, a backlight module 236, a frame 228, a film 230, a shade tape 232, and a sub display panel 234 on a side of the backlight module 236 without the main display panel 214. The backlight module 236 comprises a light source, a light guide plate 202, diffusers 210, 222, 204, 222, and a prism sheets 208, 206, 224, 226. The light guide plate 202 is made from propylene and has functions of guiding light and controlling light uniform. The diffusers 210, 222, 204, 222 has scatter particles are able to diffuse the light. Furthermore, the prism sheet 208, 224, 226 are made form poly carbonic ester and are able to condense the light to increase brightness. Moreover, the film 230 could use 3M's reflective dual brightness enhancement film (DBEF) and Nitto's polarization conversion film (PCF) or any new material to achieve the same function of polarizing and reflecting the light.

A light path is beginning from the light guide plate 202 and divides into two paths, one is toward a main display panel 214, the other is toward a sub display panel 234. A multi-layer structure between the main display panel 214 and the sub display panel 234 is backlight module in FIG. 2.

When a light is shot from a light source into a light guide plate 202, the light guide plate 202 will guide the light to divide into the above-mention two paths into the main display panel 214 and the sub display panel 234. In FIG. 2, only drawing paths I′ and II′ illustrate. In path I′, the light is shot into light guide plate 202 and sequentially gets into a diffuser 222, a horizontal prism sheet 224, a vertical prism sheet 226, and the light reflects from a frame 228 into the light guide plate 202, the light gets into the diffuser 204, a horizontal prism sheet 206, a vertical prism sheet 208, a diffuser 210, finally, the light without a shade tape 232 covers is able to reach the main display plane 214 and gets out form the main display plane 214.

In Fig. II′, the light is shot into light guide plate 202 and sequentially gets into a diffuser 222, a horizontal prism sheet 224, a vertical prism sheet 226, and the light without a frame 228 cover will get into the opening 229 and a film 230. The film 230 is an optics film has function of polarizing and reflecting the light. When the light gets into the film 230, the film 230 will permit a specific direction polarized light pass and reflect a vertical specific direction polarized light. As FIG. 2 shown, the film 230 divides the light into a P polarized light and a S polarized light, the P polarized light will pass the film and keep going, but the S polarized light will be reflected. The P polarized light without the shade tape 232 cover will shoot into the sub display panel 234. The transmit axle of the polarized light layer 232 is parallel with the P polarized light, that causes the P polarized light could pass through the polarized light layer 232 into a liquid crystal of the sub display panel 234 to show an image. In the other words, the S polarized light is reflected into the light guide plate 202 as path III′ of FIG. 2 shown. Because a transmit axle of the polarized light layer 213 of the main display panel 214 is vertical with a transmit axle of the polarized light layer 233 of the sub display panel 234, the S polarized light is reflected into the main display panel 214 to produce image.

Deserving to mention is the light source of the present invention could change amount and position according to the demands. The light source is made from the cold cathode fluorescent (CCFL) and LED. Moreover, the prism sheets 206, 208, 224 and 226 are composed by a section of the parallel sheet and the vertical sheet to condense the light and increase brightness. Except the embodiment mentioned prism sheet, the lecticular sheet could achieve the same effect. Furthermore, the liquid crystal display 200 according to the present invention could change a material and a sequence of the backlight module.

Because the liquid crystal display 200 has the single light guide plate according to the present invention comprises the film 230, the main display panel 214 has the path I′ light and the path III′ light. Comparing to the prior art, the main display panel 114 of the prior art only has the path I light. The present invention could give the main display panel 214 enough light source and the shadow is not produce easily. Besides, the sub display panel 234 of the present invention could use the path II′ light as the prior art does, so the present invention prevent the shadow to happen and give enough light to the main display panel 214 and the sub display panel 234.

In the short words, the present invention sets the film before the light go through the sub display panel, the polarized light could not pass through the first polarized light layer of the sub display panel will reflect to the light guide plate. The first transmit axle of the main display panel is vertical with the first transmit axle of the sub display panel, the polarized light could get into the main display panel. Comparing to the prior art, the present invention increases the brightness of main display panel and decreases the shadow happen. In the same time, the light guide plate and the backlight module are not responsible to improve the problem of the shadow of the main display panel.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A structure of a dual display liquid crystal display (LCD), the structure comprising:
a backlight module;
a main display panel forming a side of the backlight module;
a sub display panel forming the other side of the backlight module without the main display panel;
a film forming between the sub display panel and the backlight module, the film being been shot through by a specific direction polarized light and being able to reflect a vertical specific direction polarized light.

2. The structure of claim 1, wherein the sub display panel comprises a first polarized light layer on a side of the sub display panel near the backlight module.

3. The structure of claim 2, wherein the first polarized light layer has a transmit axle is parallel with the specific polarized light.

4. The structure of claim 2, wherein the main display panel comprises a second polarized light layer on a side of the main display panel near the backlight module, and a transmit axle of the second polarized light layer is vertical with the transmit axle of the first polarized light layer.

5. The structure of claim 1, wherein the backlight module comprises:
a light guide plate (LGP) is parallel with the main display panel and the sub display panel; and
a light source on a side of the light guide plate.

6. The structure of claim 1, wherein the light source is made from a cold cathode fluorescent (CCFL) and a light emitted diode (LED).

7. The structure of claim 1, wherein the specific direction polarized light selects from a P polarized light and a S polarized light.

8. The structure of claim 1, wherein the backlight module comprises at least a first diffuser and at least a first prism sheet between the sub display panel and the light guide plate.

9. The structure of claim 8, wherein the backlight module comprises a plurality of first prism sheets, that comprises a plurality of prism lens and a plurality of lenticular lens and each prism sheet is vertical to the next prism sheet.

10. The structure of claim 1, wherein the dual display liquid crystal display further comprises a first shade tape between the sub display panel and the backlight module.

11. The structure of claim 1, wherein the dual display liquid crystal display further comprises a frame between the light guide plate and the sub display panel, an opening of the frame permits the backlight module light into the sub display panel.

12. The structure of claim 11, wherein the dual display liquid crystal display further comprises a reflector close to a side of the light guide plate is able to reflect light toward the light guide plate.

13. The structure of claim 11, wherein the film is on a side of the opening.

14. The structure of claim 11, wherein the film is between the frame and the sub display panel.

15. The structure of claim 11, wherein the backlight module further comprises at least a second diffuser and at least a second prism sheet between the main display panel and the light guide plate.
